(19) United States
(12) Patent Application Publication
(10) Pub. No.: US 2018/0222391 A1
(43) Pub. Date: Aug. 9, 2018

(54) Multi-function, Network Linked Smart Rearview Mirror

(71) Applicant: Da Xiang CHEN, Guangzhou (CN)

(72) Inventor: Da Xiang CHEN, Guangzhou (CN)

(21) Appl. No.: 15/423,598

(22) Filed: Feb. 3, 2017

(51) Int. Cl. B60R 1/12; B60R 1/04; B60K 35/00; H04N 5/232; H04N 5/247; H04N 7/18

(52) U.S. Cl. CPC B60R 1/12; B60K 2350/357; B60K 35/00; H04N 5/23293; H04N 5/247; H04N 7/181; H04N 5/23216; B60R 2300/105; B60R 2001/1253; B60R 2300/207; B60R 2300/8006; B60R 2300/806; B60R 2300/8073; B60R 2325/205; B60R 2325/106; B60K 2350/927; B60K 2350/104; B60K 2350/106; B60K 2350/1088; B60K 2350/2013; B60K 2350/2095; B60R 1/04

(57) ABSTRACT

A rear view mirror system comprises cameras, a central control board, a hidden screen display, a touch pad, and a wireless control button array. The cameras are for recording continuous video inside, outside, or around a vehicle, taking snapshots, and providing real time photo and video information to remote monitoring devices on a user request. The hidden screen display is installed in a mirror of the vehicle for providing operational information of the one or more cameras and the vehicle. The touch pad is connected electronically to the central control board for receiving user control actions. The wireless control button array is for allowing a user to send action commands to mirror. At least one of the remote monitoring devices is configured for receiving and presenting the real time photo and video information from the cameras and controlling the operations of the cameras.

### TECHNICAL FIELD

This invention is to create a smart rearview mirror, which is capable to be network connected and provide rich functions like video recording, navigation and remote security monitoring.

### TECHNICAL BACKGROUND

1. The current DVR (video recording) devices for vehicles are mostly a separated electronic box/pack. It is install by mounted on windshield, dashboard etc. It takes up the space and block the driver's eye sights while driving. These dash cam designs makes the driving unsafe.

2. Existing in car navigation system is located in the middle of dashboard. Most of the navigation system has local data only, but without online data feedbacks. Drivers cannot get real time driving routes and traffic information. This outdated routes can be misleading, or can lead the driver into a traffic jammed roads.

3. The existing in-vehicle smart systems are mostly equipped by car manufactures. These closed systems can provide designed functions only. Users can not extended new features.

3. The existing in-vehicle electronics are lacks of infrastructures for SOS request. There is no security mechanism provided for notifying emergent contacts with real-time location and real-time images.

4. The vehicle is not seamless monitored with connection to Internet cloud or other information devices.

5. For those monitored vehicle, users lacks of an integrated, easy to control user applications.

### SUMMARY OF INVENTION

A rear view mirror system comprises one or more cameras, a central control board, a hidden screen display, a touch pad, and a wireless control button array.

The one or more cameras are configured for recording continuous video inside, outside, or around a vehicle, taking snapshots, and providing real time photo and video information to a plurality of remote monitoring devices on a user request.

The central control board is equipped with an operating system and software packages for controlling operations of the one or more cameras.

The hidden screen display is installed in a mirror of the vehicle and configured for providing operational information of the one or more cameras and the vehicle.

The touch pad is connected electronically to the central control board for receiving user control actions.

The wireless control button array is configured for allowing a user to send action commands to mirror.

At least one of the plurality of remote monitoring devices is configured for receiving and presenting the real time photo and video information from the one or more cameras and controlling the operations of the one or more cameras.

The one or more cameras may comprise a front facing camera as a main camera, a internal facing camera as backup camera, a down-facing back camera for reverse parking video, and a horizontally-facing back camera for rearview streaming.

The hidden screen display may be configured to be turned on and off by the user through the touch pad, the wireless control button array, and the central control board.

At least one of the plurality of remote monitoring devices may be linked with an Internet.

The plurality of remote monitoring devices may comprise a smartphone, a tablet computer, a notebook computer, a personal computer, and a server in the Internet.

At least one of the plurality of remote monitoring devices may comprise a plurality of remote control applications configured for: receiving a real-time notification on engine start and engine stop, wherein the notification contains information of location of the vehicle, date, and time; checking historical driving route records, wherein the historical driving route records contain locations and speeds of the vehicle and a total distance, an average speed, a maximum speed of the vehicle; monitoring a vehicle real-time information, wherein the user requests and checks images or video streams from the front facing camera, the back facing camera, the internal facing cameras; and reviewing historical photo records, which are exported, saved, and sorted by time and locations in the system.

The rear view mirror system may further comprise a mirror software installed in the mirror, wherein the historical photos are captured by the cameras and saved in a mirror memory installed in the mirror, and the mirror software keeps checking availability of network connections and once a data network is connected, the mirror software uploads the captured historical photos to the server, and the server sorts by time and locations, and organizes the records in a table storage, so that a user accesses the historical photos and records using at least one of the plurality of remote monitoring devices.

An extended GPS antenna head may be provided and connected to the mirror for stronger GPS signal receiving.

The rear view mirror system may further comprise a back-end cloud database configured for storing data of the user, the vehicle, the one or more cameras, and GPS track.

The rear view mirror system may further comprise a mirror software installed in the mirror and configured for allowing the user to: review the historical video from the one or more cameras with functions including play, stop, delete of video files in the historical video; input navigation destinations and select the navigation modes; take instant real-time photos using the one or more cameras; send a real-time SOS request by triggering SMS text messages and email messages in the plurality of monitoring devices; and select, download, install, un-install new third party applications in the one or more monitoring devices.

The rear view mirror system may further comprise an automotive software installed in the vehicle configured for operating the hidden screen display in the mirror without a user interaction in: detecting the engine start/stop by sensors and start/stop DVR features automatically; monitoring the G-sensor data, trigger snapshots if car is hit or stopped, causing G-sensor data sudden sharp change; monitoring the vibrations during the vehicle's moving or parking and sending notification to remote monitoring applications; monitoring and sensing temperature and humidity in the vehicle, so that once over limit threshold, the mirror software notifies remote monitoring applications; keeping listening to a network connection for user's operation commands, and providing image or video feedback; and setting up alarm after the engine is stopped, and bringing the mirror software offline/power off based on pre-set parameters.

The rear view mirror system may further comprise a FM transmission component for redirecting audio information from the one or more cameras into an in-car radio system.

The rear view mirror system may further comprise slots and connectors configured for installing SIM card, installing SD storage card, and connecting USB cables for debugging or data fetching.

The rear view mirror system may further comprise a cable bundles configured for battery power, ACC on/off detection power, reverse parking detection, temperature and humidity sensors, vibration sensors, and USB/video-in cables for the one or more cameras.

The software packages may comprise a mirror software installed in the mirror, a server software installed in the server for running the system, and a user software app installed in at least one of the plurality of remote monitoring devices.

The advantages of the present invention are: (1) the rear view mirror system according to the invention provides a convenient system for monitoring inside, outside, and the status of the vehicle in a remote monitoring device such as a smartphone; and (2) the rear view mirror system according to the invention can be applied to a vehicle easily, enabling a smart monitoring system for the vehicle.

Although the present invention is briefly summarized, the fuller understanding of the invention can be obtained by the following drawings, detailed description and appended claims.

### BRIEF DESCRIPTION OF DRAWINGS

These and other features, aspects and advantages of the present invention will become better understood with reference to the accompanying drawings, wherein:

FIG. 1 is a schematic diagram showing a rear view mirror system according to an embodiment of the invention;

FIG. 2 is a block diagram showing connections between a rear view mirror system and periphery components according to an embodiment of the invention;

FIG. 3 is a block diagram showing a hierarchy of databases for user data management according to an embodiment of the invention;

FIG. 4 is a flow chart showing a video stream recording according to an embodiment of the invention;

FIG. 5 is a screen shot showing icon boxes for a navigation system according to an embodiment of the invention;

FIG. 6 is a schematic diagram showing a SOS request according to an embodiment of the invention;

FIG. 7 is a schematic diagram showing a GPS tracking according to an embodiment of the invention;

FIG. 8 is a flow chart showing snapshot taking schematic diagram showing a SOS request according to an embodiment of the invention;

FIG. 9 is a perspective view of a vehicle showing views of cameras schematic diagram showing a SOS request according to an embodiment of the invention;

FIG. 10 is a block diagram showing a rear view mirror system according to an embodiment of the invention;

FIGS. 11-20 show how to install a rear view mirror system according to an embodiment of the invention;

FIG. 21 is a perspective view showing a rear view mirror system with input and output connections according to an embodiment of the invention;

FIGS. 22-23 are perspective views showing a GPS antenna and where to install according to an embodiment of the invention;

FIGS. 24-38 show how to use a rear view mirror system according to an embodiment of the invention;

FIGS. 39-48 show how to use a rear view mirror system using a smartphone application according to an embodiment of the invention;

FIG. 49 is a table showing technical specifications according to an embodiment of the invention;

FIG. 50 is a table showing a packing list according to an embodiment of the invention; and

FIG. 51 is a table showing a FAQs.

### DETAILED DESCRIPTION OF EMBODIMENTS OF THE INVENTION

Referring to the figures, the embodiments of the invention are described in detail.

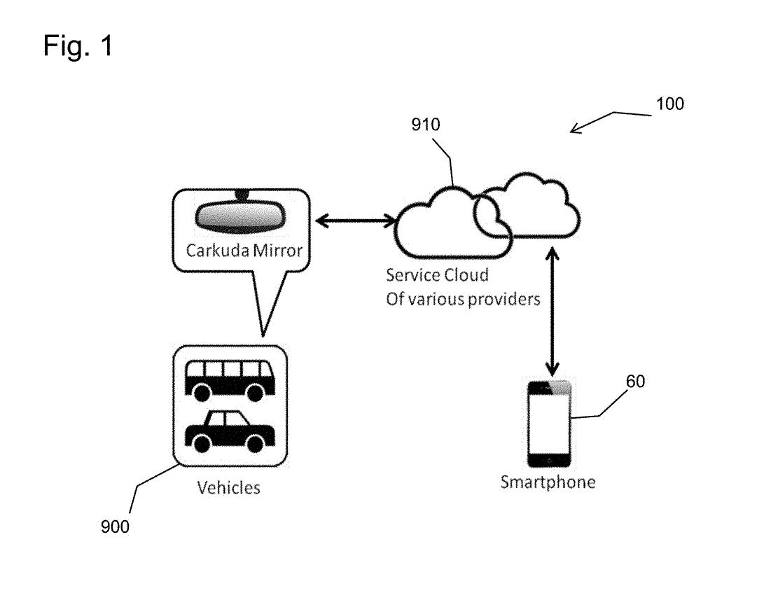

An aspect of the present invention provides a rear view mirror system, Carkuda®, as shown in FIGS. 1-9.

Carkuda is consist of multiple components. The mirror is the main hardware components which is install in vehicle. It comprises camera, main boards, screen, mirror, and other wirings. The service cloud is the central data hub for the whole Carkuda system. It stores the database and responses to other components service requests. The Smartphone (or PC) end is the users control point. Carkuda has related application software to be installed on those control end devices.

Carkuda System Architecture
Carkuda Mirror is installed in vehicles
Carkuda hardware connect to battery, ACC power line, reverse signal line, GPS antenna
With data network, mirror talks to Services Cloud
Data network can be combination of 2G/3G/4G/Wi-Fi
Services cloud can be public known like Google Map, or manufacturer provided cloud
User can user Carkuda Mirror directly by touch screen
Smartphone connect to Mirror by data network
Smartphone access mirror data from Service Cloud
   Carkuda Mirror Connections with Periphery Components.

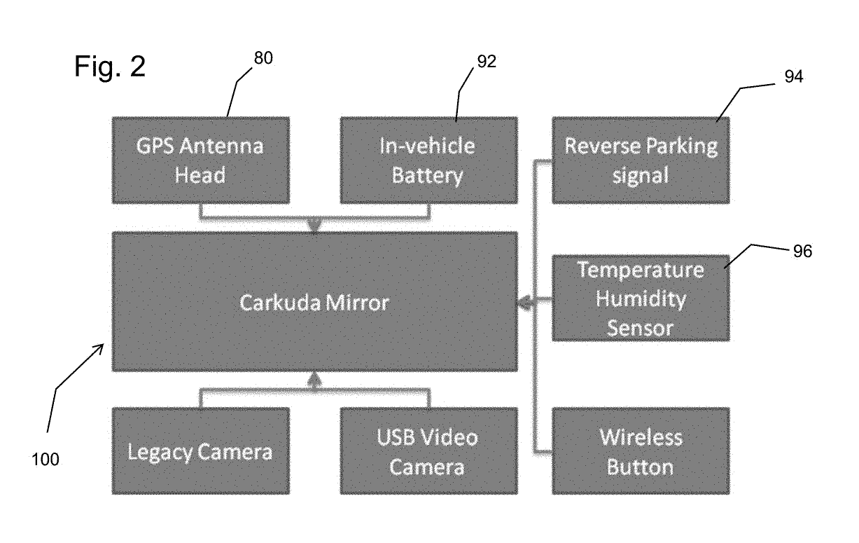

Mirror connect itself to related components to realize full functions. FIG. 2 illustrates the details of connections.

The connection standard from Carkuda mirror to different periphery uses different standards. For GPS antenna, it is the standard GPS signal lines base on its frequencies ranfge. For battery, power, ACC and parking signal, it's plain mental lines. The wireless button, which is optional, is connected with open frequency 2.4 GHz based on Bluetooth 4.0 standard. For Legacy camera, the connection is legacy video-in lines. For high definition digital video, the connection is use USB3.0 lines, which is enforced with signal amplifier hub.

### Managing User Data

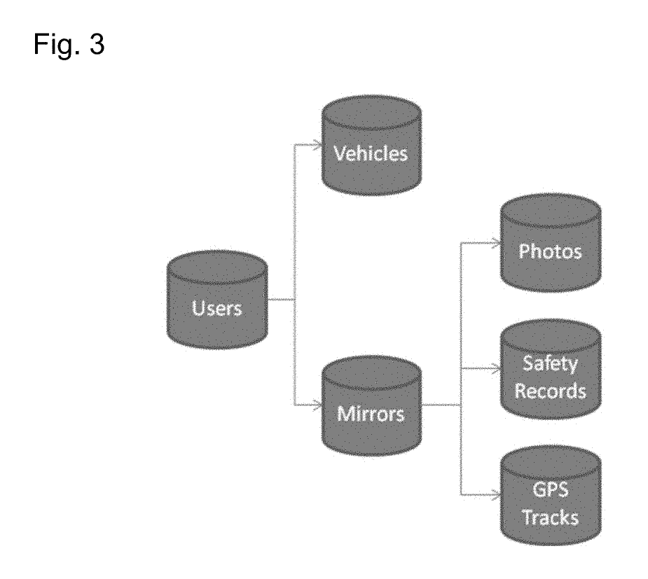

Carkuda has back-end service cloud as illustrated in FIG. 1. One of the key components is the database for user, vehicle, and mirror etc. The central role is user. On the application end, a user can create the own accounts by providing an Email or mobile phone number. With accounts, users can create virtual vehicle data, which represents a vehicle in the real world. System maintains a unique identification number for each mirror. The ownership of mirror is enforced by a relationship record. Creating the relationship is binding process. On the application (Smartphone/PC), with ID number and PIN number, the system will create a record of binding. All access of mirror data need authorization of user. Under the mirror table, database system has photos, safety records and GPS tracks. The hierarchy of the database is listed as shown in FIG. 3. The conversation between mirror to server, Smartphone to server are all dynamically encrypted.

### Realization of DVR Functions

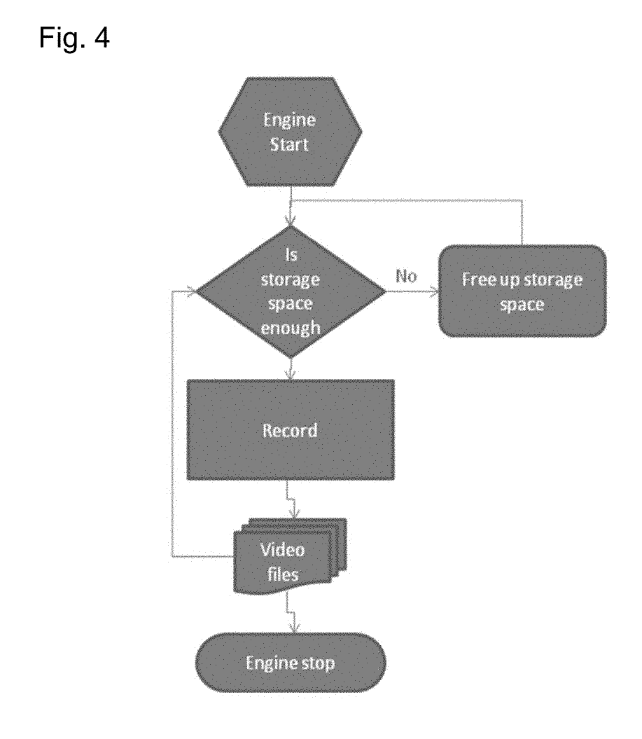

The mirror is composes of multiple cameras. Once the car engine is turned on, in-mirror application will start the recording. And application will setup the camera parameters according to user preferences. The DVR process will chop the video stream for a new video file for every 3 minutes. If the DVR storage is full, process will start to delete the oldest video, which is recorded before, to free up space for new recordings, as shown in FIG. 4. During the recording process, users can change the recording parameters. These include: 1. change between high definition to full high definition video; 2. change to record or not to record voice; 3. Grasp the current image and save it to cloud photo albums; 4. Stop/resume the recording.

The DVR stream the video data and encode as MPEG-4 standard. At the meantime, mirror application will add time stamps onto the video files. During the DVR recording process, mirror application handles other photo requests simultaneously. Photo request includes but not limited to snapshots by user, remote security monitoring.

### Navigation System Management

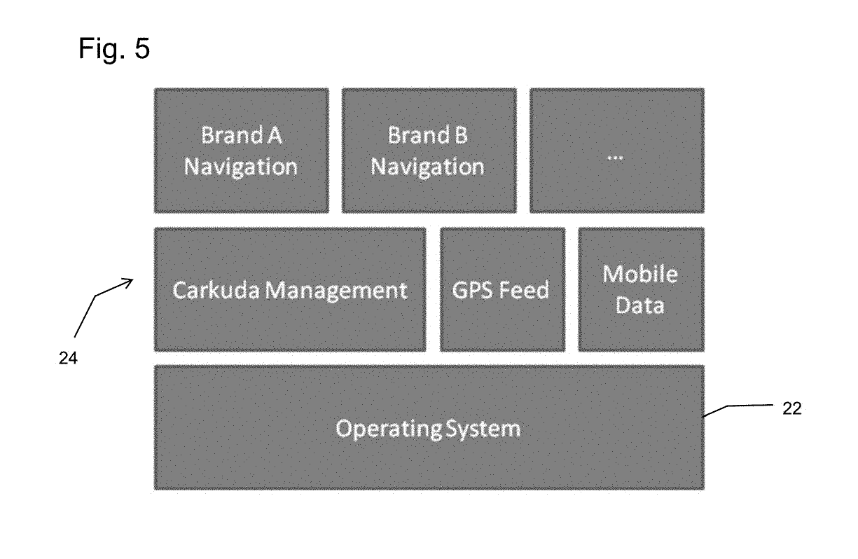

Carkuda system integrates the existing branded navigation applications. Carkuda host navigation systems is provided with additional inputs like GPS feed, mobile data. During the navigation process, Carkuda system provide full access for each navigation system. Carkuda offer icon boxes on the screen for users to select the navigation applications as shown in FIG. 5.

### SOS Request

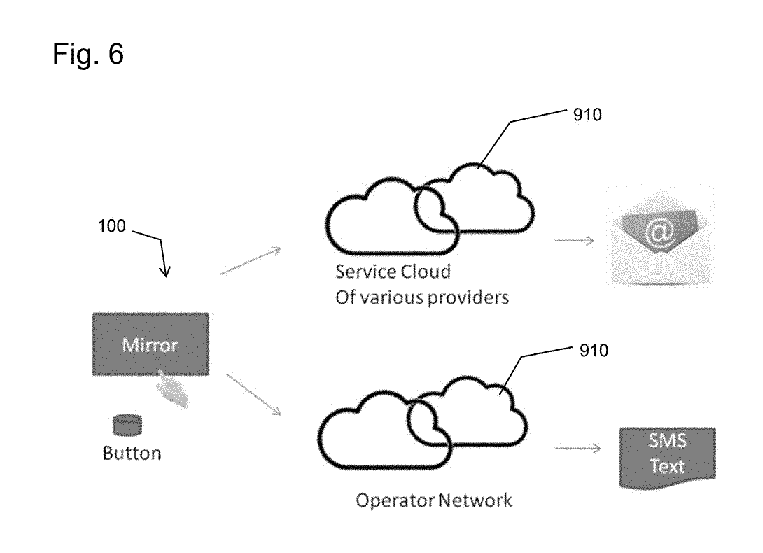

Carkuda system has two levels of SOS notifications: Email and SMS text, as shown in FIG. 6. For email the account is set with maximum two emergent contacts. This parameters are control on applications in Smartphone list in FIG. 1. For SMS, the contact data is stored in mirror. Once user trigger the SOS alerts by click on touch pad in mirror or click on the wireless button. Carkuda Mirror application will request service from cloud to send the Email. The content of Email contains necessary information like text description, address, images attachments. Meanwhile, mirror local application uses the operator services to send SMS text, with pre-set text and real time address. To get the address, mirror software will use the GPS coordinates and sent to service provide to translate into plain text.

### GPS Tracking

Carkuda mirror keep record the GPS locations every three seconds. The location contains the longitude, latitude and its current speed measured by kilo meters per hour. Whenever three minutes timer hits, the system will upload the track data onto service cloud database. The tracking data is secured stored, and the transmission is encrypted with dynamic handshake parameters.

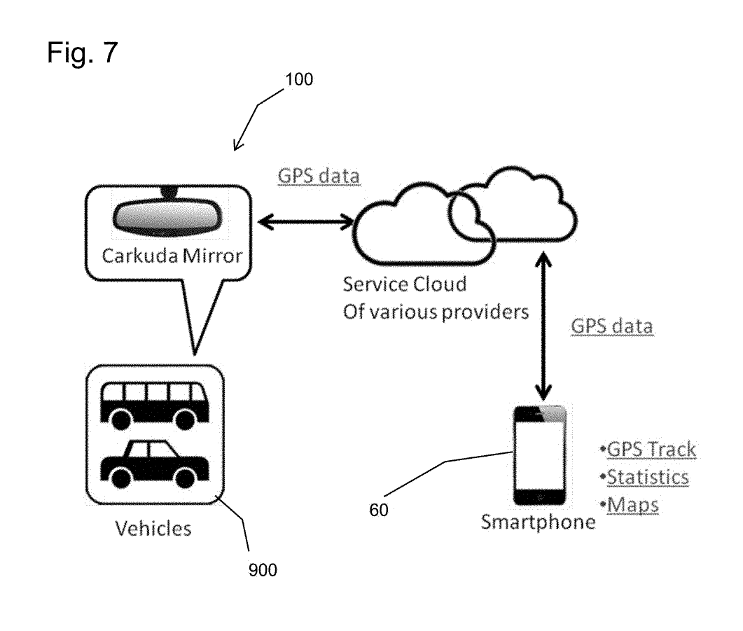

From applications on Smartphone, user make request from service cloud database. Tracking data is packed and downloaded to user devices. Then the Smartphone app will display the tracks on maps. With top speed, average speed, total kilo meters calculated as shown in FIG. 7.

Among the statistics, the data is calculated as below:

Total kilometers=SUM(All distances between ACC on and ACC off)

Average speed=(Total kilometers tracked)/Total duration

Top speed=MAX(All speed recorded during the selected day)

### Taking Snapshots

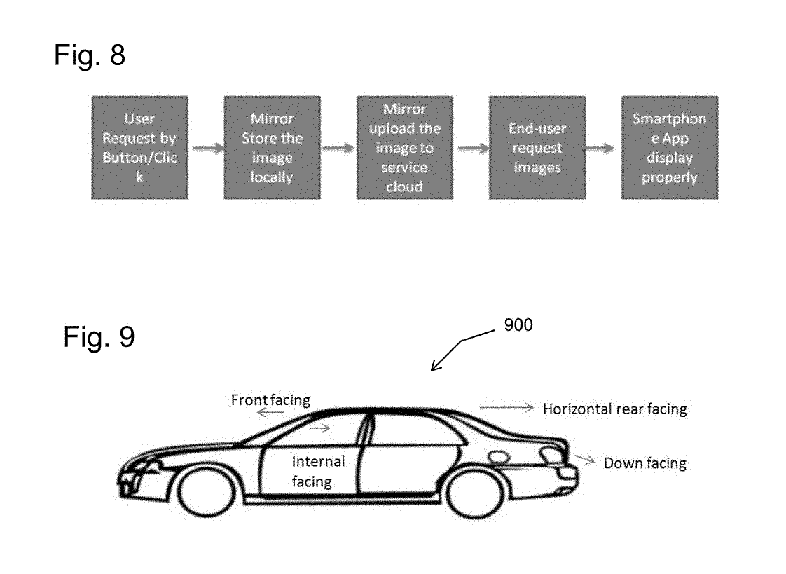

Based on user request, Carkuda mirror can take the image from camera sensors. Once the image is taken, then it is first stored into internal memory (On-board Flash, or TF-SD card). The mirror then process the images for better quality. After this is done, mirror application will try pushing the photo data onto service cloud. End users can access the photo snapshot data via Smartphone applications. The process for this is illustrated in FIG. 8.

### Handling Online Offline Switching

To enhance the user experience, Carkuda handle the online offline switching smoothly. By online offline switching, it means the network access from mirror will experience different signal levels which causes lost of data connections. If this is not carefully handled, such environment change will cause data lost forever, image missing or record missing etc.

Carkuda mirror application, together with service cloud, works in an innovative way to smooth the data transfer process. Mirror applications maintains a local buffer to store the data and acknowledge the transfer process before clean up any piece of local buffer data.

The local buffer contains the records of:
Every engine start/stop, time stamp, location address
Images request by users
GPS track data
Granted user accounts
Service cloud servers address

Whenever the events happened, the mirror keep track of all and write into the local buffer as a transfer intermediate mechanism. If the mirror is online, which means the data connection is properly set, then the dedicated upload process will use the established connection with service cloud to upload the records and data. Once the service cloud confirms the records are stored, then the upload process can delete the buffer record locally. If the mirror offline, the record are firstly store in the mirror's local storage. Meanwhile the upload process will keep monitoring the network data connection. Once it is resumed, the records upload returns to normal process. In this way, Carkuda system can tackle the fast environment change of network connection. This makes the data records are all consistent.

### Real-time Security Video and Imaging

Mirror applications keeps alive for services response. Started from engine start, mirror application create a network services socket, and then listen to any incoming request for video and images. Considering the privacy, mirror application introduce a authentication process to grant the access to camera data.

Due to the variety of network structure and access type (3G/4G/Wi-Fi), Carkuda system transfer the messages in a faster and reliable fashion. The service cloud acts the central hub for message exchange. When user request images or video from Smartphone application, the service cloud will dispatch the request to the proper mirror, which has internal unique identification numbers.

### Reverse Parking Video

In the mirror, front camera is a digital high definition camera. It is display as the default camera. To implement the parking video, there are few points to adjust for this. First is the user interface. Normally the mirror interface displays the functional icons. Once the signal detected for reverse parking, the video preview window will be maximized on bring onto the top of user views. The video streaming will switch the stream from front camera to back down-facing packing camera. For the down-facing back camera, Carkuda mirror setup dedicated chipset to process the image, it enhances the video quality by brightness, sharpness and color rebalancing. The dedicated chipset algorithms

### Power Management

Carkuda mirror has connection with battery. Normally vehicle has limited battery capacity. Carkuda will stay in a standby mode once the car engine is off. Carkuda has power management algorithms to protect this battery life.

In the mirror, the [Settings] section provide an item to modify the delay time of standby. Carkuda mirror setup a timer once the car engine is turned off. And as time goes, the timer hit. Carkuda mirror will command the operating system to shutdown the whole system to save power consumptions.

### Engine Monitoring

Carkuda has dedicated line connected to ACC signal line. The voltage level is different between ACC on and ACC off. Carkuda mirror software package keep checking the voltage level in a fast frequency (each 50 milliseconds). The change of voltage is filtered for a moving average. Once the voltage cross the moving average, the mirror application will trigger the monitoring events. That causes the system to send record to services cloud.

### Redirecting Sounds Via FM Transmission

The sounds from Carkuda Mirror is normally transfer to in-mirror speaker. To enhance the sound effect, Carkuda introduce FM radio mechanism. Carkuda mirror has dedicated radio module for FM transmission. On the mirror user can select certain frequency, which is ranging from 80 MHz-150 MHz, which is public radio frequency range.

The Key Points of this Invention and Benefits

### Network Linked Rearview Mirror

Carkuda innovatively design the mirror with network connection. This opens the opportunities to introduce advanced features on to linked mirror.

### Application Controlled Rearview Mirror

Carkuda is the first to bring integrated application for car mirror monitoring.

### Multiple Camera Management

Carkuda introduce four camera for car security monitoring.

Integrated DVR

Unlike dash cam, by integrating DVR into rearview mirror the space is saved. The eye sight is more clear while driving.

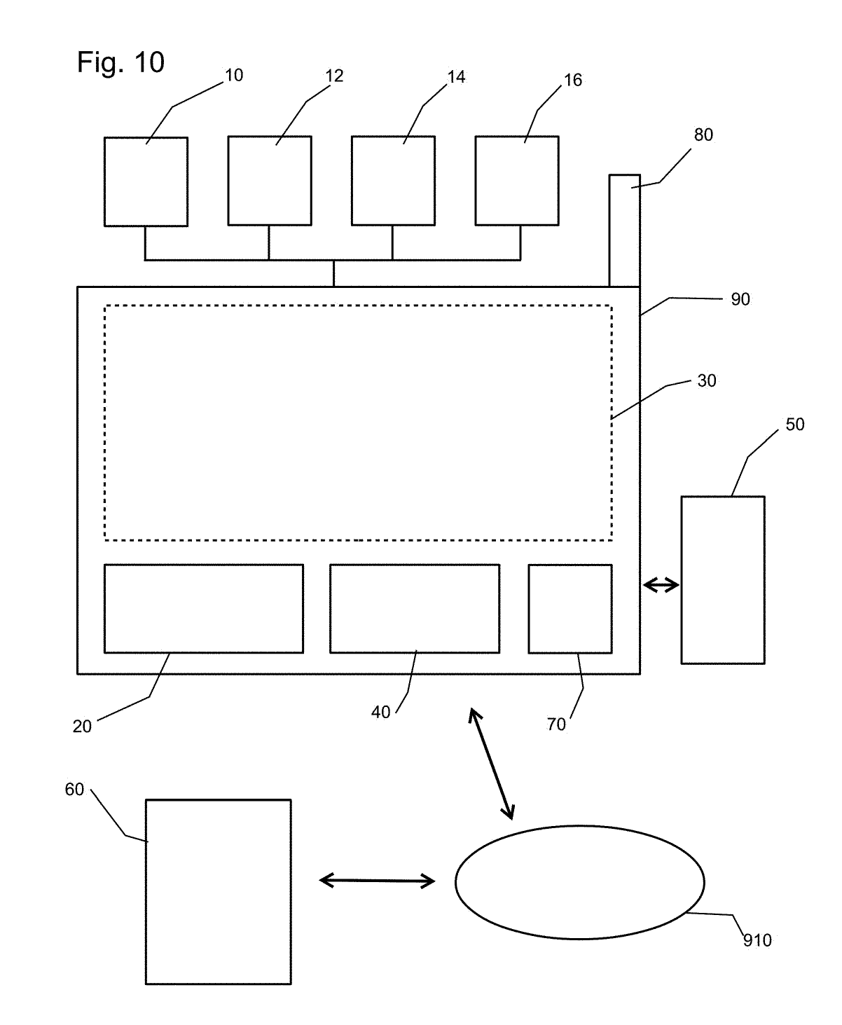

An aspect of the invention provides a rear view mirror system 100 comprising one or more cameras 10, a central control board 20, a hidden screen display 30, a touch pad 40, and a wireless control button array 50 as shown in FIG. 10.

The one or more cameras 10 are configured for recording continuous video inside, outside, or around a vehicle 900, taking snapshots, and providing real time photo and video information to a plurality of remote monitoring devices 60 on a user request.

The central control board 20 is equipped with an operating system 22 and software packages 24 for controlling operations of the one or more cameras 10, 12, 14, 16 as shown in FIG. 5.

The hidden screen display 30 is installed in a mirror 90 of the vehicle 900 and configured for providing operational information of the one or more cameras 10, 12, 14, 16 and the vehicle 900.

The touch pad 40 is connected electronically to the central control board 20 for receiving user control actions.

The wireless control button array 50 is configured for allowing a user to send action commands to the central control board 20 of the mirror 90. The wireless control button array 50 may be provided in the mirror 90, more specifically on a portion of exterior surface of the mirror 90 or on a certain portion of the hidden screen display 30. In certain embodiments of the invention, the wireless control button array 50 may be provided in a form of a remote controller.

At least one of the plurality of remote monitoring devices 60 is configured for receiving and presenting the real time photo and video information from the one or more cameras 10, 12, 14, 16 and controlling the operations of the one or more cameras 10, 12, 14, 16.

The one or more cameras 10, 12, 14, 16 may comprise a front facing camera 10 as a main camera, a internal facing camera 12 as backup camera, a down-facing back camera 14 for reverse parking video, and a horizontally-facing back camera 16 for rearview streaming as shown in FIG. 9.

The hidden screen display 30 may be configured to be turned on and off by the user through the touch pad 40, the wireless control button array 50, or the central control board 20.

At least one of the plurality of remote monitoring devices 60 may be linked with an Internet or any communication network 910 as shown in FIGS. 1 and 7, for example.

The plurality of remote monitoring devices 60 may comprise a smartphone, a tablet computer, a notebook computer, a personal computer, and a server in the Internet as shown in FIGS. 1 and 7.

At least one of the plurality of remote monitoring devices 60 may comprise a plurality of remote control applications configured for: receiving a real-time notification on engine start and engine stop, wherein the notification contains information of location of the vehicle 900, date, and time; checking historical driving route records, and the historical driving route records contain locations and speeds of the vehicle 900 and a total distance, an average speed, a maximum speed of the vehicle 900; monitoring a vehicle real-time information, and the user may request and check images or video streams from the front facing camera 10, the back facing camera 14, 16, the internal facing cameras 12; and reviewing historical photo records, which are exported, saved, and sorted by time and locations in the system.

The rear view mirror system 100 may further comprise a mirror software installed in the mirror 90, wherein the historical photos are captured by the cameras 10, 12, 14, 16 and saved in a mirror memory 70 installed in the mirror 90, and the mirror software keeps checking availability of network connections and once a data network 910 is connected, the mirror software uploads the captured historical photos to the server in the data network 910, and the server sorts by time and locations, and organizes the records in a table storage, so that a user accesses the historical photos and records using at least one of the plurality of remote monitoring devices 60 as shown in FIG. 7.

An extended GPS antenna head 80 may be provided and connected to the mirror 90 for stronger GPS signal receiving as shown in FIG. 10.

The rear view mirror system 100 may further comprise a back-end cloud database 910 configured for storing data of the user, the vehicle 900, the one or more cameras 10, 12, 14, 16, and GPS track as shown in FIG. 7. In the community, it is well known that the vehicle 900 can detect its own status parameters and supply to an external device.

The rear view mirror system 100 may further comprise a mirror software installed in the mirror 90 and configured for allowing the user to: review the historical video from the one or more cameras 10, 12, 14, 16 with functions including play, stop, delete of video files in the historical video; input navigation destinations and select the navigation modes; take instant real-time photos using the one or more cameras 10, 12, 14, 16; send a real-time SOS request by triggering SMS text messages and email messages in the plurality of monitoring devices 60; and select, download, install, un-install new third party applications in the one or more monitoring devices 60 as shown in FIGS. 6 and 7.

The rear view mirror system 100 may further comprise an automotive software installed in the vehicle 900 configured for operating the hidden screen display 30 in the mirror 90 without a user interaction in: detecting the engine start/stop by sensors and start/stop DVR features automatically; monitoring the G-sensor data, trigger snapshots if car is hit or stopped, causing G-sensor data sudden sharp change; monitoring the vibrations during the vehicle's moving or parking and sending notification to remote monitoring applications; monitoring and sensing temperature and humidity in the vehicle 900, so that once over limit threshold, the mirror software notifies remote monitoring applications; keeping listening to a network connection for user's operation commands, and providing image or video feedback; and setting up alarm after the engine is stopped, and bringing the mirror software offline/power off based on pre-set parameters.

The rear view mirror system 100 may further comprise a FM transmission component for redirecting audio information from the one or more cameras into an in-car radio system.

The rear view mirror system may further comprise slots and connectors (not shown) configured for installing SIM card, installing SD storage card, and connecting USB cables for debugging or data fetching.

The rear view mirror system 100 may further comprise a cable bundles (not shown) configured for battery power 92, ACC on/off detection power, reverse parking detection 94, temperature and humidity sensors 96, vibration sensors, and USB/video-in cables for the one or more cameras 10, 12, 14, 16 as shown in FIG. 2.

The software packages may comprise a mirror software installed in the mirror 90, a server software installed in the server 910 for running the system 100, and a user software app installed in at least one of the plurality of remote monitoring devices 60.

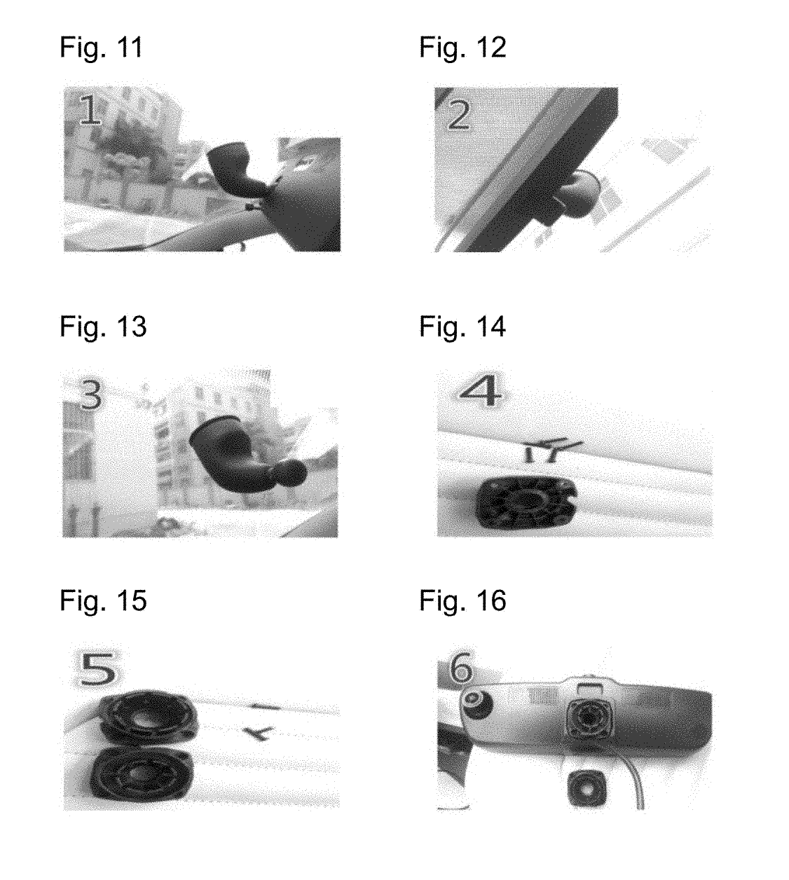

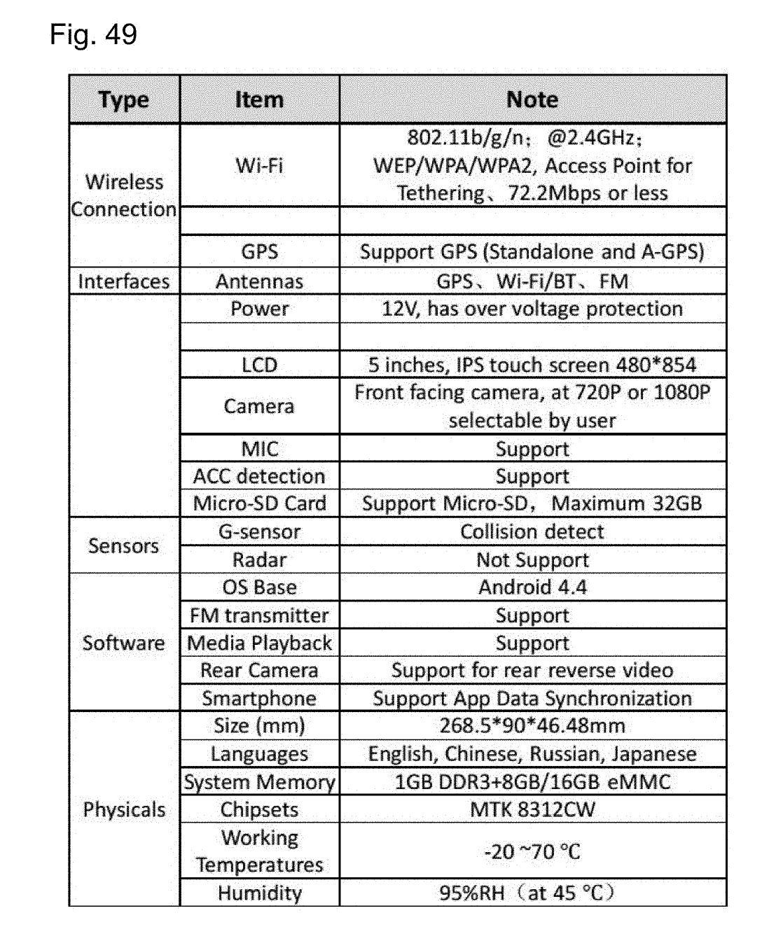

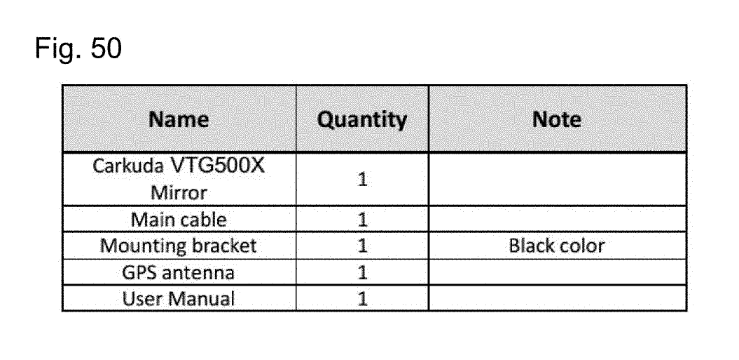

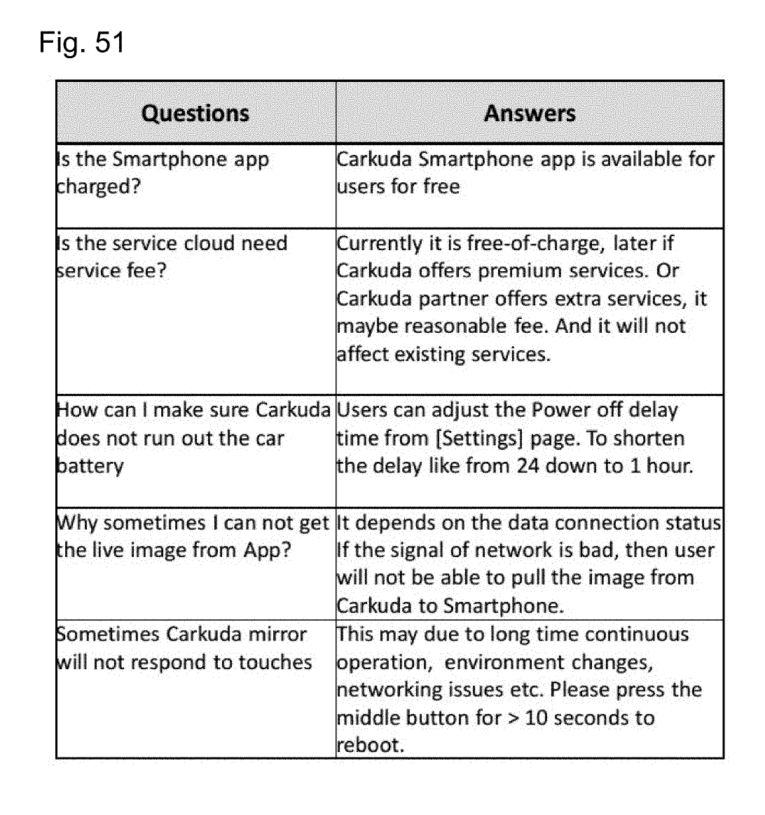

FIGS. 11 through 50 show an example of a user manual for a rear view mirror system 100 according to an embodiment of the invention.

The concepts of Carkuda, a rear view mirror system 100 according to an embodiment of the invention, are shown in FIG. 1, including: Carkuda Mirror is installed in vehicles
Carkuda hardware connect to battery, ACC power line, reverse signal line, GPS antenna
With data network, mirror talks to Services Cloud
Data network is Wi-Fi network
Services cloud can be public known like Google Map, or manufacturer provided cloud
User can user Carkuda Mirror directly by touch screen
Smartphone connect to Mirror by data network
Smartphone access mirror data from Service Cloud

As shown in FIGS. 11 and 12, the device may be provided with a universal plastic bracket.

In FIG. 11 and FIG. 12,
Please identify if your car mirror has a round connector with mounting bracket.
If yes, then please turn the switch and take the original mirror off from the bracket.

In FIGS. 13 and 14,
Keep the mounting bracket on the windshield as it is. We will use this stand as the base for universal plastic mounting bracket.
Within this bracket kit, we have 5 screws. There are 4 for Installation and 1 for backup purpose in case your lost them.

In FIGS. 15 and 16,
Please select the proper size head circle according to your Existing mounting bracket. Place the plastic head and drive the screws into the mirror.

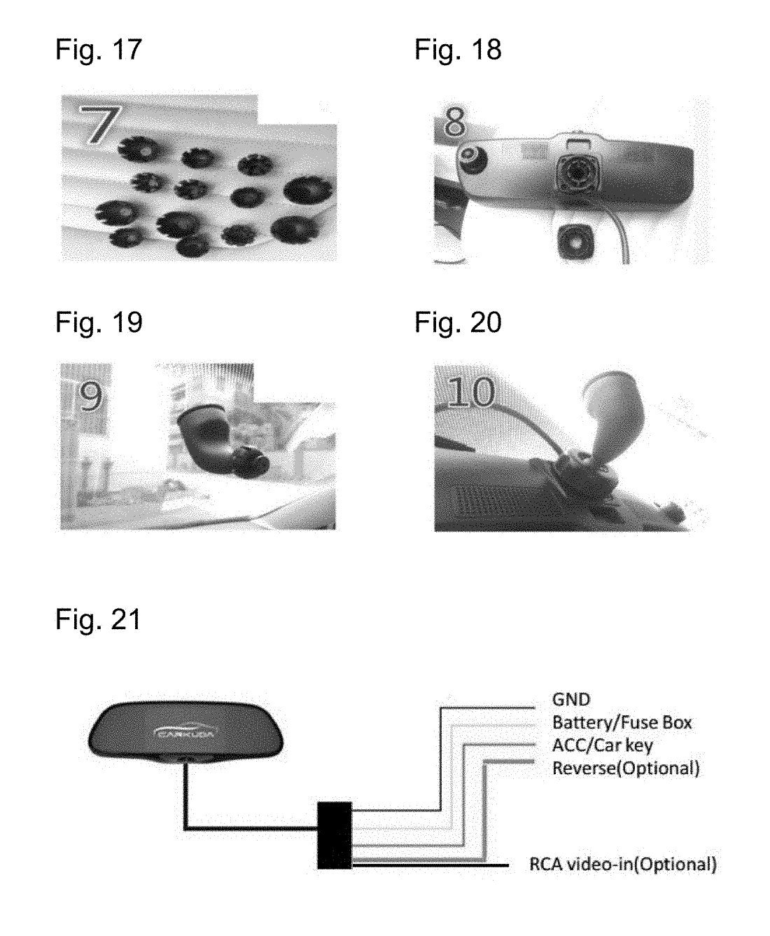

In FIGS. 17 and 18,
There many size of plastic circles for tightening purpose Please try and select the proper one for your mounting size.

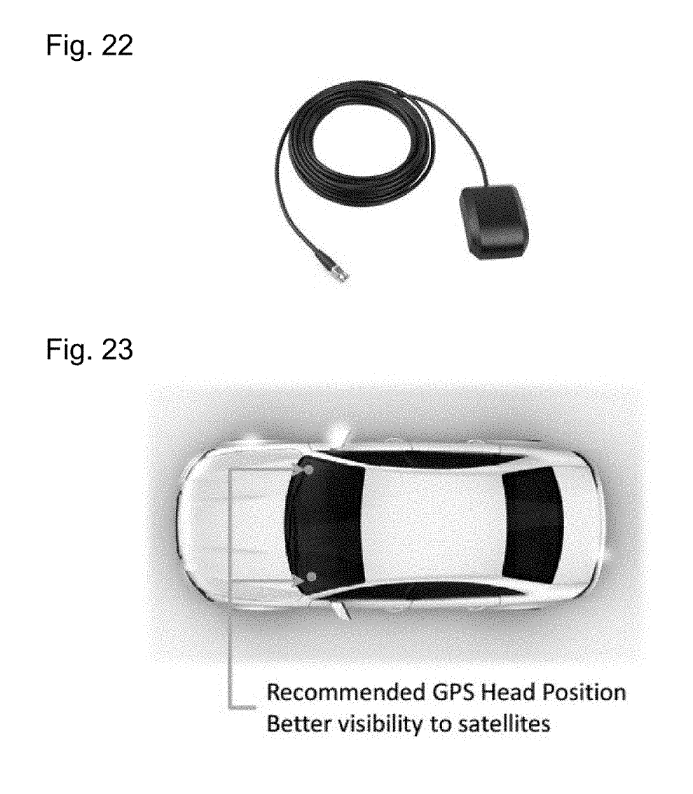

In FIGS. 19 and 20,
You can test the size of circle caps by putting onto the bracket. At last, please put the circle cap, screw head and twist them tightly.
   In FIG. 21, Carkuda requires battery power after vehicle is turned off. This is because users need to access Carkuda real time data remotely via Smartphone. Carkuda also need to connect ACC signal line to offer security monitoring features. With signal line connected, Carkuda can detect every ACC on/off event.
   There are a bundle of cables with different colors. Please connect:
   The black one with GND connector
   The yellow one with battery, from fuse box or battery
   The red one with ACC cable, which indicate the car is on/off
   The blue one is use to detect reverse signal for reverse packing
video (Optional feature)
   The Green line to FM antenna (Optional)
   The RCA video-in, for reverse parking video
Warnings
   DO NOT mix the +/− of battery connectors.
   DO NOT connect red line with battery, otherwise Carkuda can not detect ACC on/off
   DO NOT connect yellow line on ACC power, otherwise Carkuda will shutdown itself, remote security feature will not activate.
   In FIGS. 22 and 23, We have also prepared GPS antenna. This antenna helps to receive GPS signal in a very fast and stable manner.
The recommended position to install GPS antenna head is under the windshield, and on top of dashboard. It can be left or right. Once the antenna is installed properly, we can screw the GPS signal line connectors together.

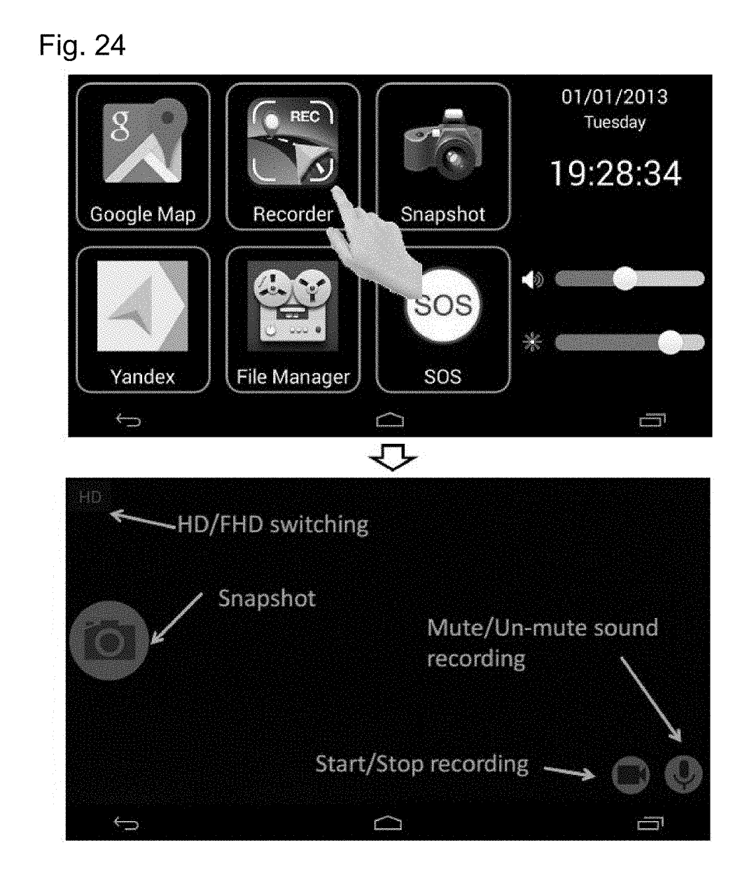

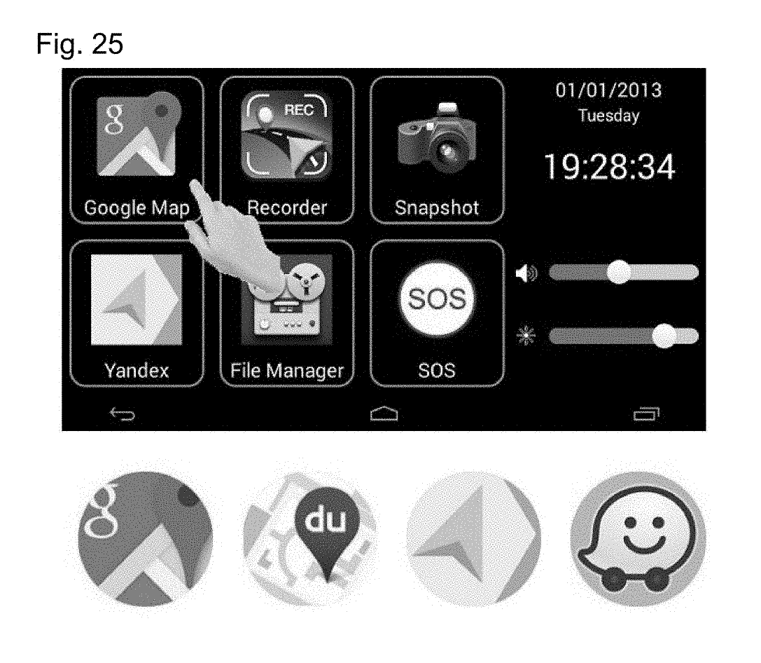

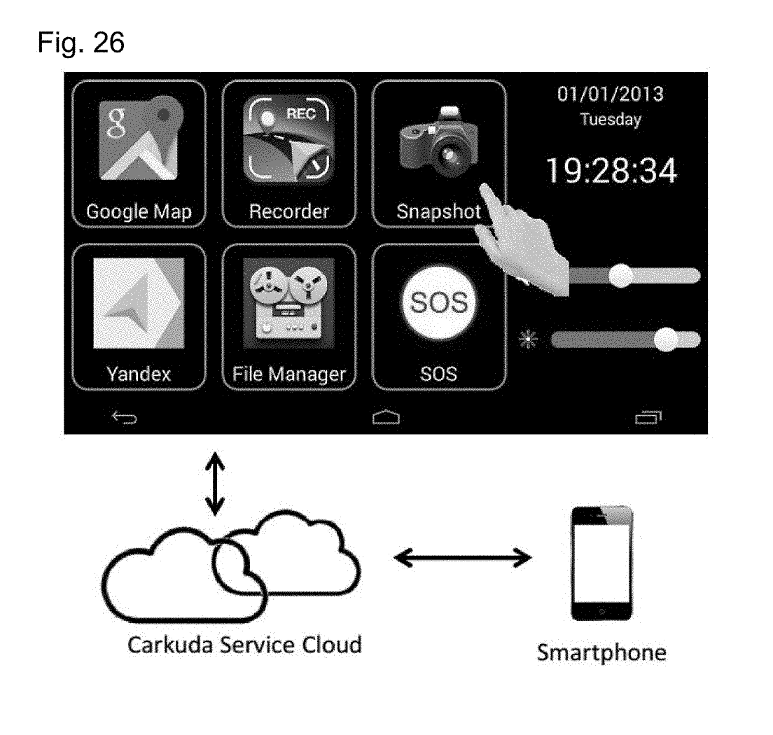

In FIG. 24, We have also prepared GPS antenna. This antenna helps to receive GPS signal in a very fast and stable manner. The recommended position to install GPS antenna head is under the windshield, and on top of dashboard. It can be left or right. Once the antenna is installed properly, we can screw the GPS signal line connectors together.

In FIG. 25, To start navigation is relatively easy. Carkuda supports various navigation systems like Google map, Yandex, Waze, Yahoo Map and many more. The user experience is same as we have on Smartphone. On the other hand,
Navigation systems require data connections to work properly.
Carkuda system can accommodate different kind of navigations. Customization is offered from Carkuda Mirror team.
Please contact manufacturer for details.

In FIG. 26, Carkuda has soft button for snapshots. When driving, the driver can instantly click on snapshot, Carkuda will capture the image and upload to cloud server, which can synchronize to your Smartphone app automatically. On the other hand,
The mirror need data connections to synchronize photos.
Carkuda currently offers cloud storage for all end users.

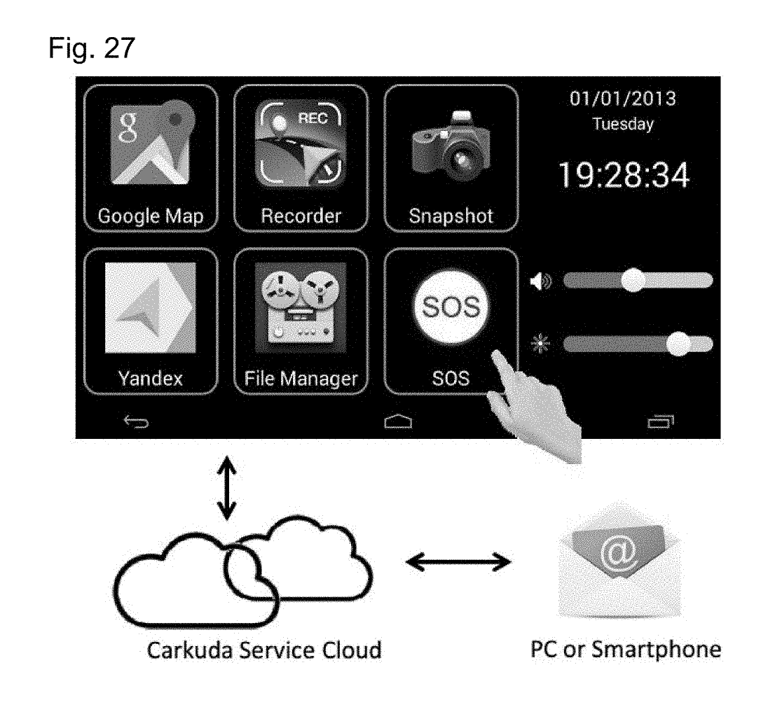

In FIG. 27, Once SOS request is pressed, the emergent contact person will receive email alerts with real time address and images attached. On the other hand,
Carkuda E-mail SOS alert is offered to users globally.
Carkuda does not grantee the delivery of E-mail due to various network situation, different mail servers etc.
Carkuda takes no commitment or responsibility.
SOS Email settings: on App, [Personal Center]->[SOS]

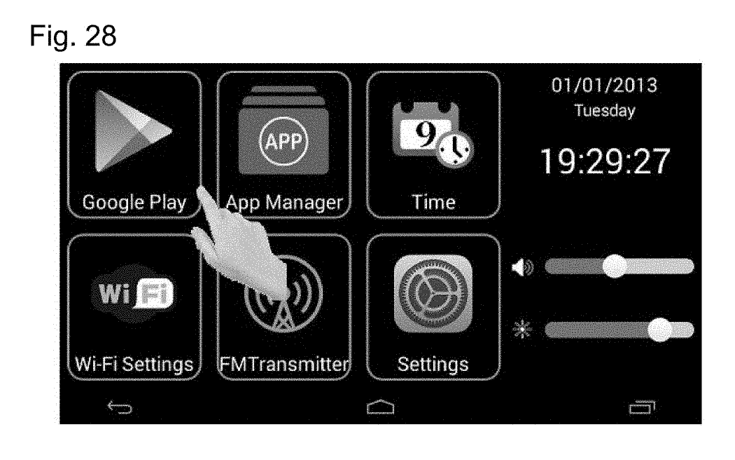

In FIG. 28, Carkuda offers Google play store feature. Users can install their favorite apps into the mirror. Once new app is installed, user can found new icons in the new pages. For performance purpose, Carkuda recommend user to install limited numbers of Applications. (Less then five apps) If the performance is degraded, please use App Manager to delete Apps accordingly. Google Play need data connections to download Apps. Google Play requires proper Google user account.

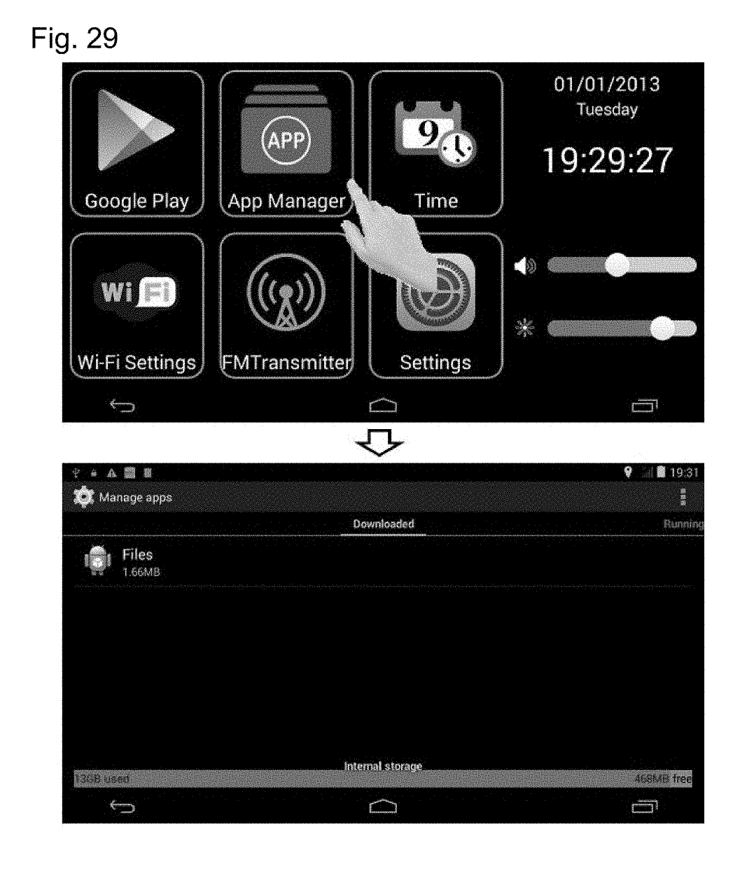

In FIG. 29, In case we need to remove app, App Manager is designed for this purpose. By click on install App, users can select to remove the app.

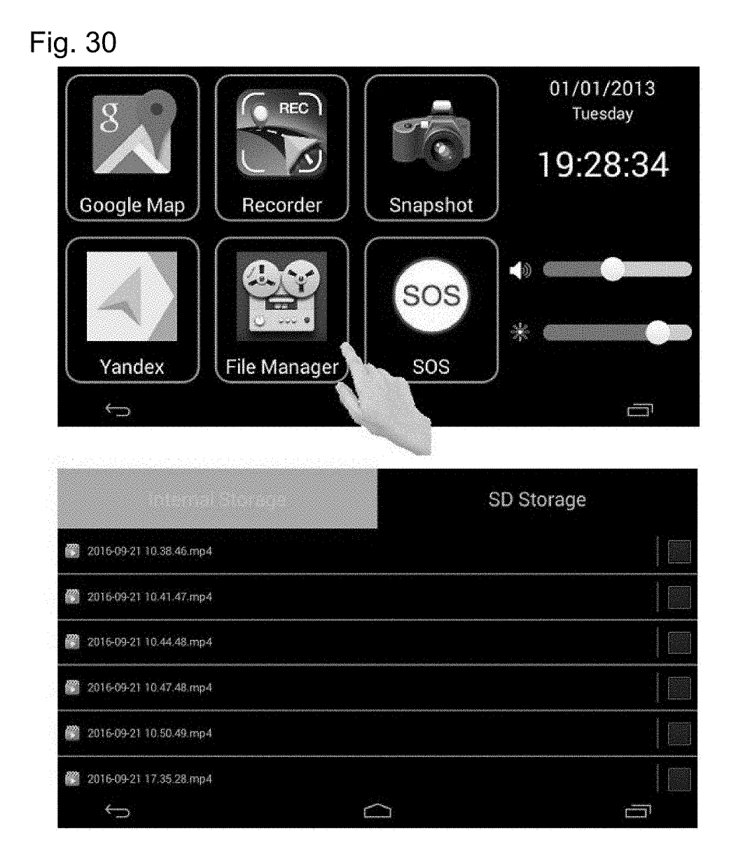

In FIG. 30, by tapping into File Manager function, users can play DVR historical videos. Delete historical video files. Clean up SD card or internal memory space.

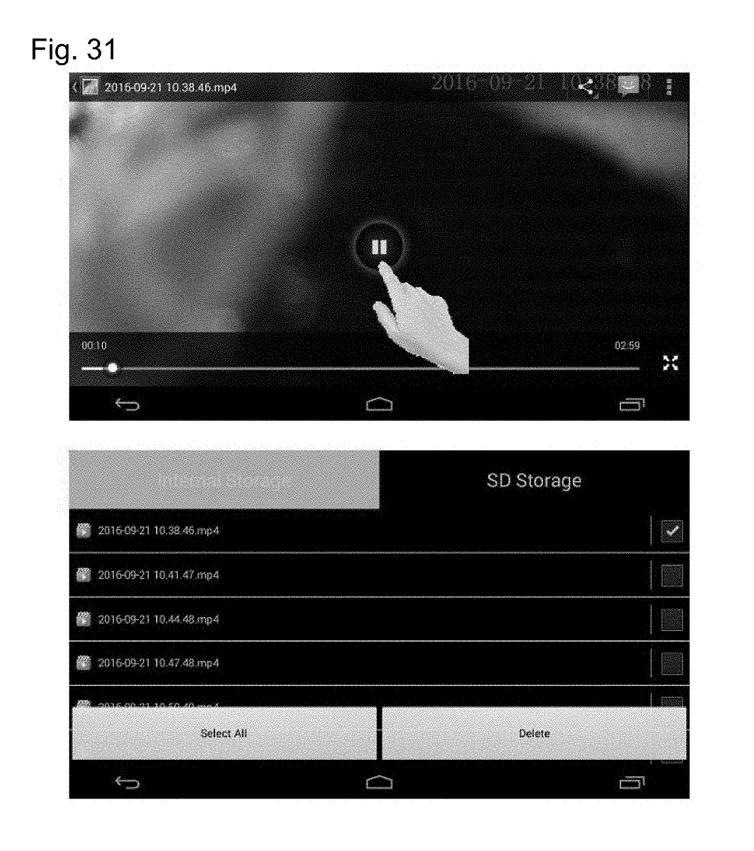

In FIG. 31, Click on the file names can start play history videos. Press return arrow on left-bottom part can quit playing. User can tick, select and delete the files as needed.

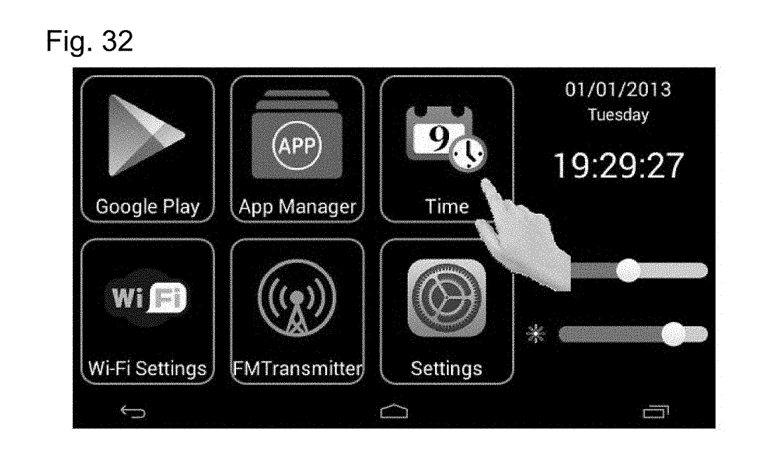

In FIG. 32, Like most of Android devices, users can set the time and date from system settings. On the other hand,
We also recommend users to stay on the default settings. But if no SIM card installed, you can turn to GPS timing for automatic date & time adjustments.
During the system running period, Carkuda will synchronize the time automatically with network server or GPS.

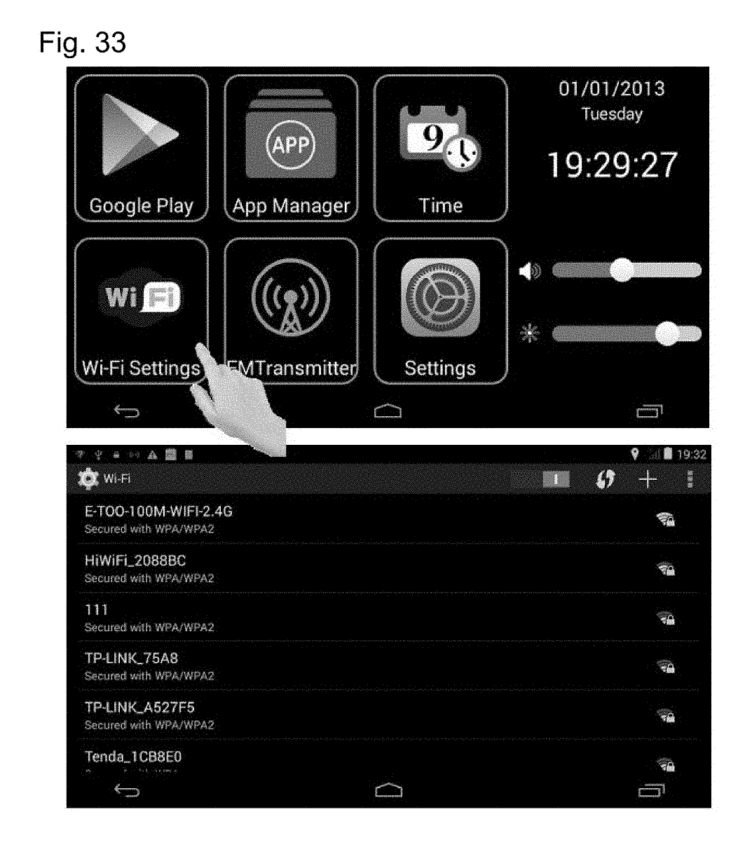

In FIG. 33, Carkuda supports Wi-Fi connection. If there are Wi-Fi networks nearby, we can click on the Wi-Fi settings, scan and log onto WiFi networks. Typically, Wi-Fi network comes from parking place, Smartphone hotspot or dedicated Wi-Fi routers.

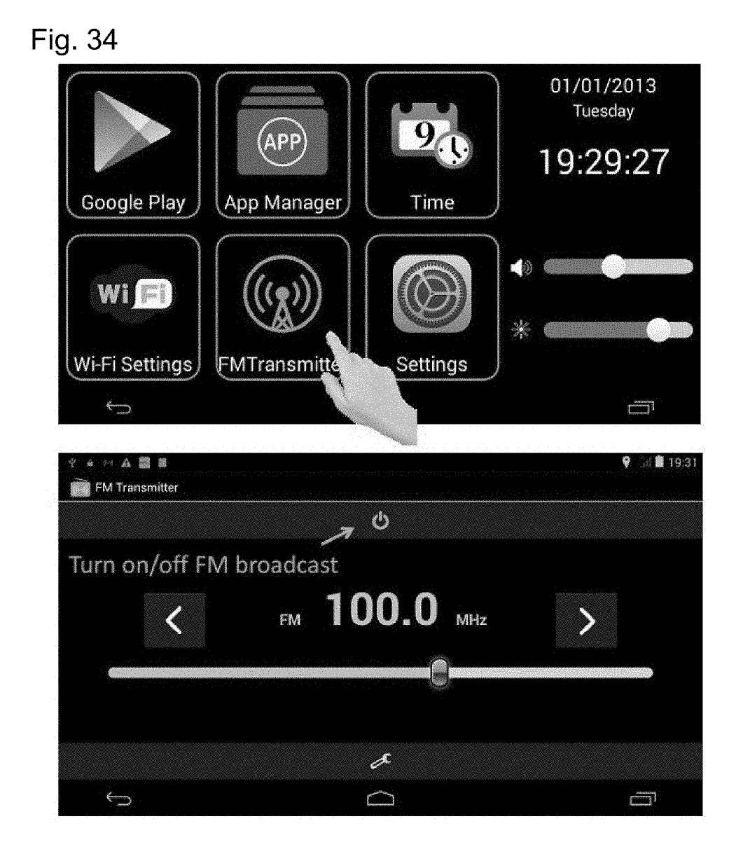

In FIG. 34, Once your car radio is tuned to the same frequency, then mirror sound will be broadcasted to your car. Remember to turn off the transmitter when you want to hear from the mirror again.

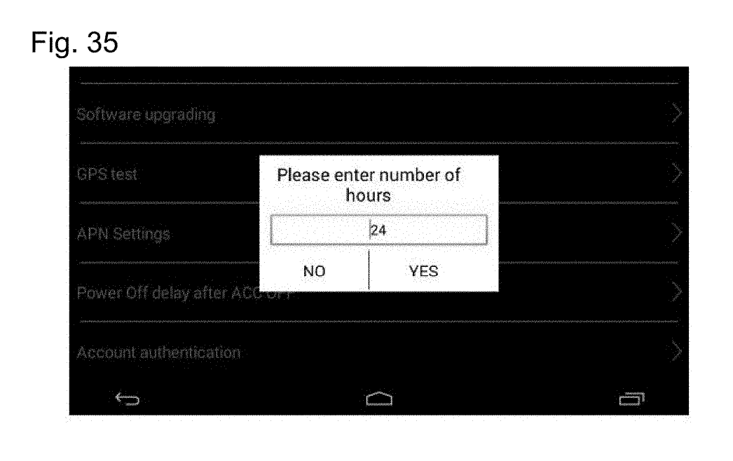

In FIG. 35, Menu: [Settings]->[Power Off delay after ACC OFF]. Since we offer remote security feature, Carkuda will be in a standby mode after vehicle is off. It will keep listening to the data network and response to remote client's request. And by default, after 24 hours, Carkuda will shutdown the mirror to save the car's battery power. To change the shutdown delay, users can navigate to the settings' last menu, type in the number of hours and click YES.

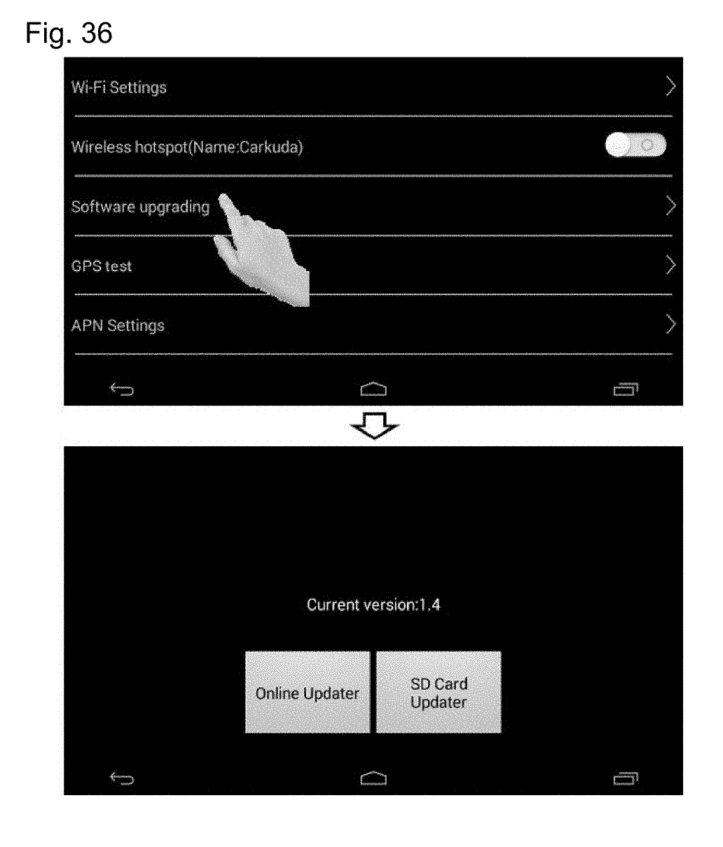

In FIG. 36, Carkuda offers online and offline SD update. Online update require data connection. Offline update files will be distributed by re-sellers.

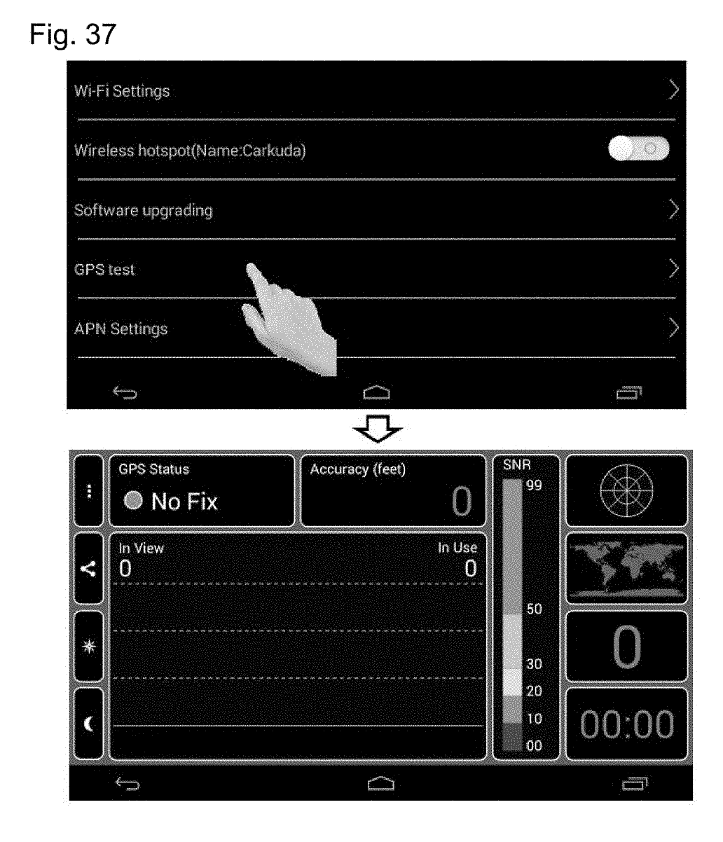

In FIG. 37, GPS test offers user a tool to check the GPS signal status. It display the number of satellite received and signal strengths.

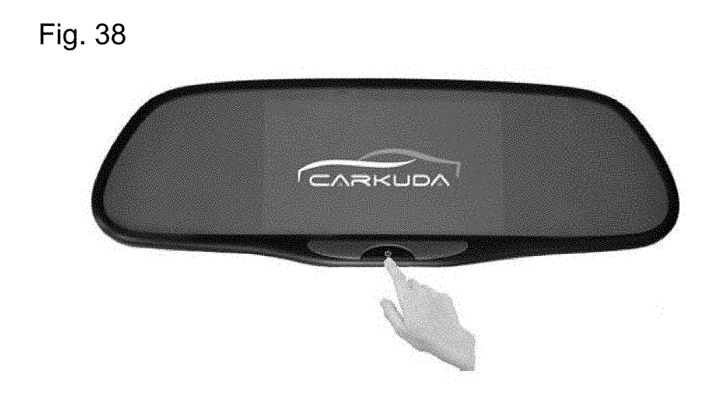

In FIG. 38, In any cases that if user experiences:
Screen freeze
Touch pad not responding
Install new SIM card
Install new SD card
etc.

Users can long press the middle button on the front face for more then ten seconds. (>10 s). Then wait for a little while, the machine shall flash the screen and re-start. If further issues, please contact your local distributors/retailers.

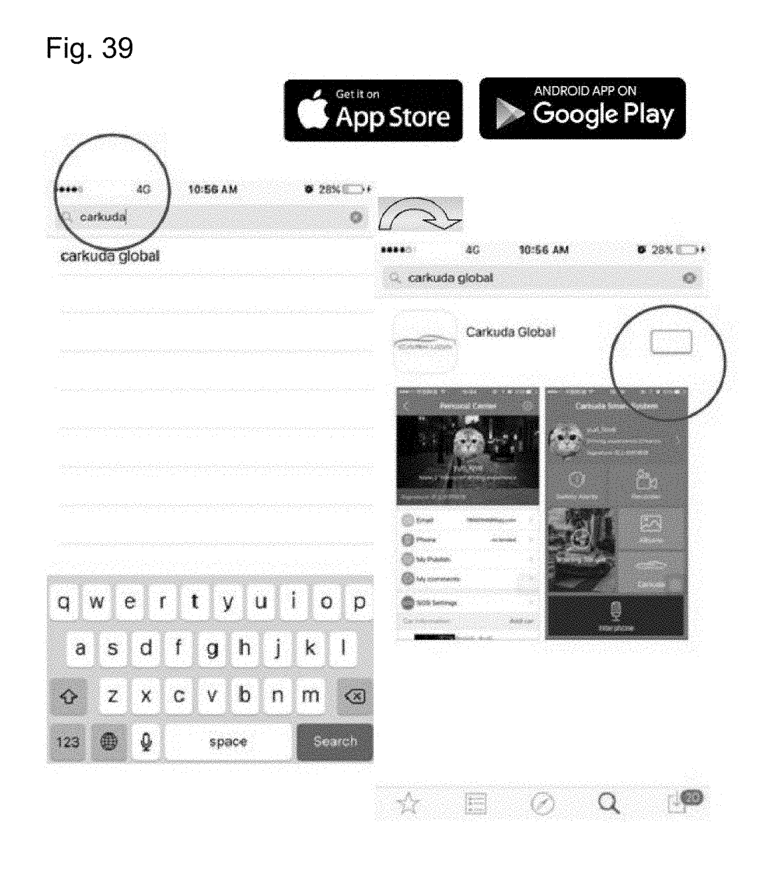

In FIG. 39, Please search for “carkuda” in AppStore or Google Play Store. Please install [Carkuda Global] App.

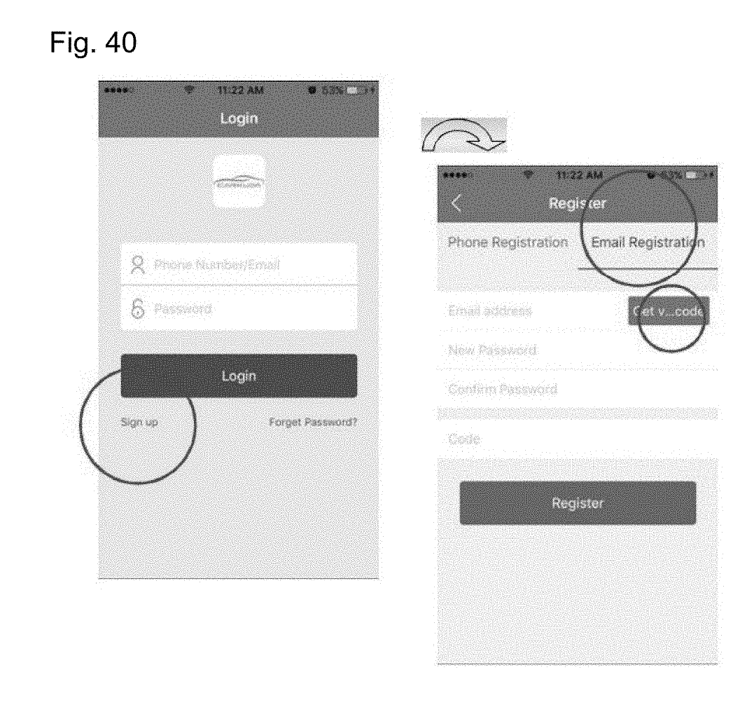

In FIG. 40, Users can register their accounts by providing a valid E-mail address, then click get verification code button and setup the passwords. Sometimes, the verification code email maybe found in your Junk Email box, depending on different email services.

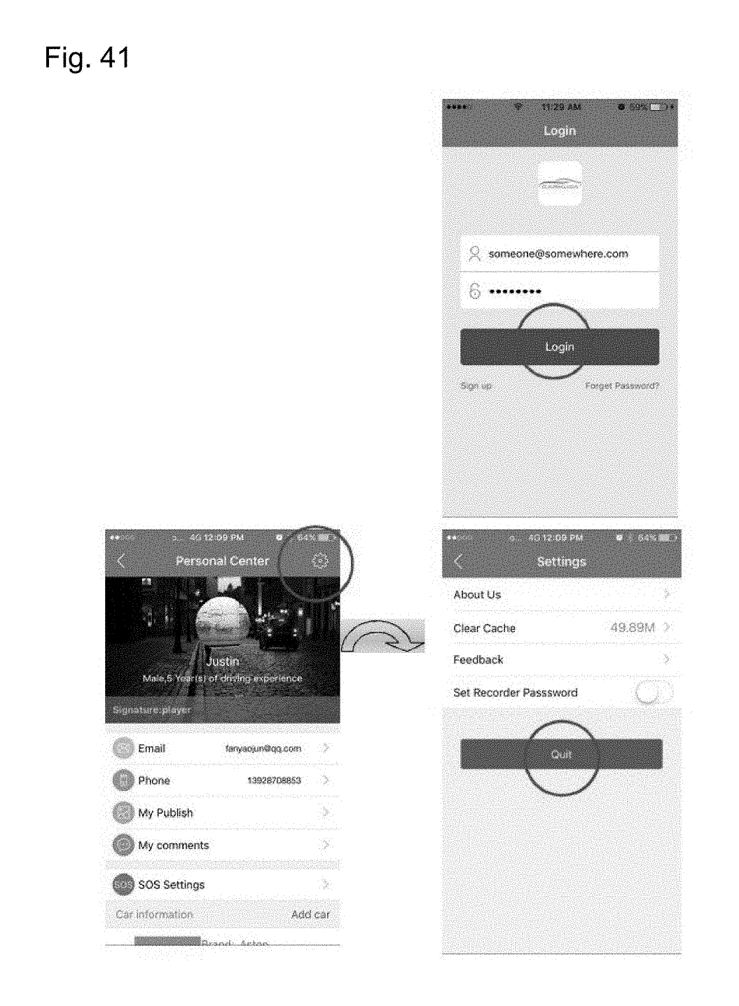

In FIG. 41, 1. To login the App, please provide the registered user email and password. Then click on Login button. 2. To logout the current user, please click into [Personal Center], then click on the icon located right-top of the screen. In [Settings] page, click [Quit] to logout.

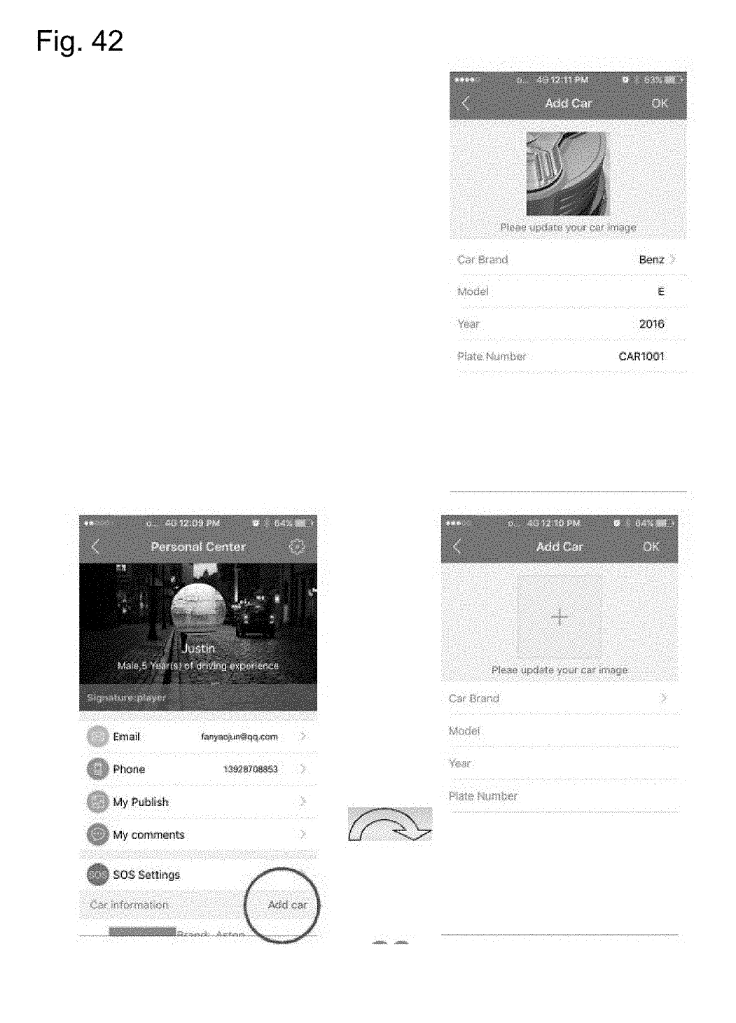

In FIG. 42, After login into the app, we need to tell the system our vehicle and mirror information. So to link all these together. In [Personal Center], you can create vehicle info by clicking [Add car]. In the new page, please provide the car image, brand, model, year and plat number. Then click [OK].

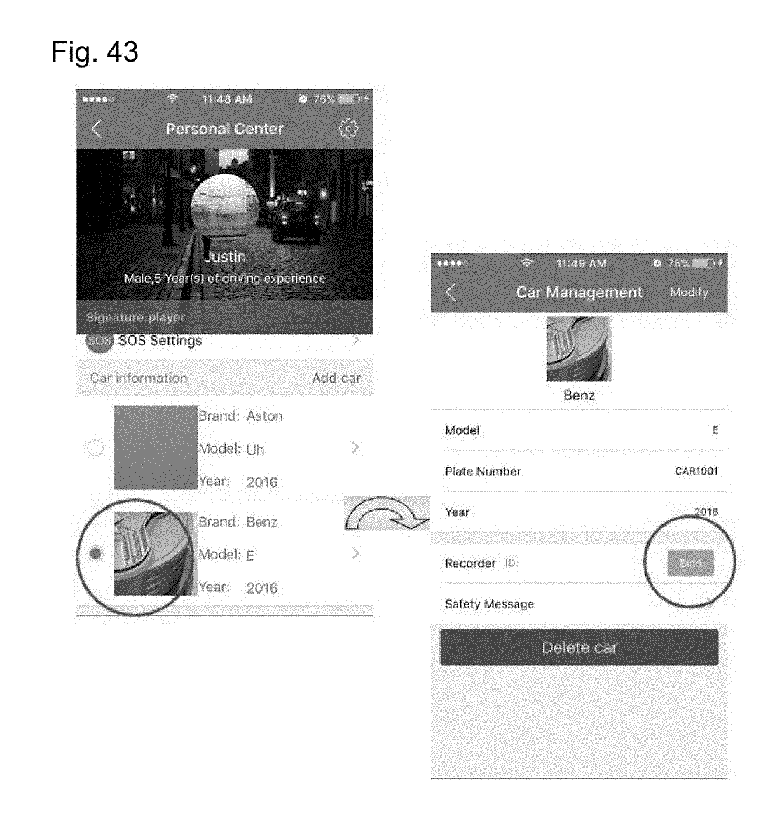

In FIG. 43, We need to bind the mirror info onto the same vehicle. By tapping into the car info, we see a green button. Click on it and provide the mirror SN and PIN number.

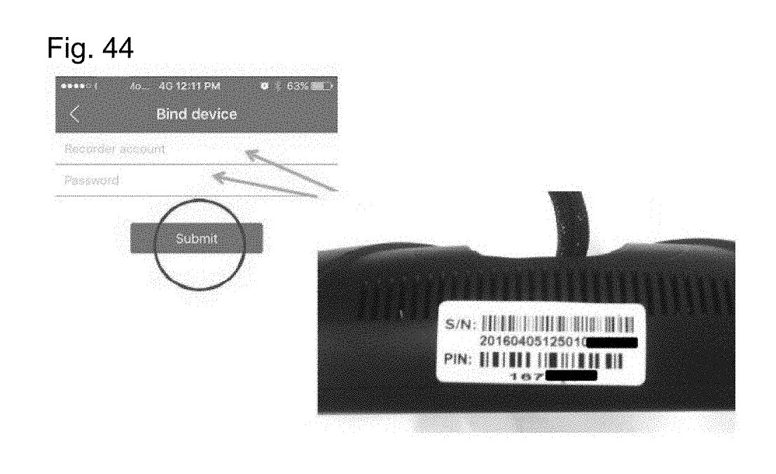

In FIG. 44, In the [Bind Device] page, the [Recorder account] equals [S/N] number, the Password equals [PIN]. The S/N and PIN can be found on the white label, which is stick on the top of mirror. On the other hand,
For security and privacy purpose, Carkuda system will allow only one account, mostly the owner, to bind on device.
This exclusive right maximize the data security (ACC record, GPS track, live images etc.)
Before other account can access the data, owner shall un-bind first to release this exclusive right.

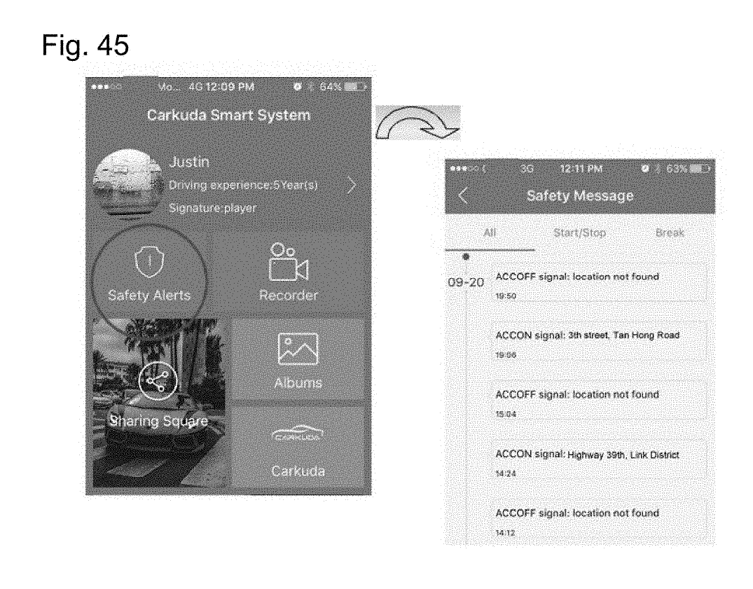

In FIG. 45, The first block is safety message. It records your car's every engine start stop events, with time and locations information listed. If hard break is detected, then message will be sent to App too. On the other hand, the locations names depend on the GPS signal. If no signal, then the location will be recorded as [location not found].

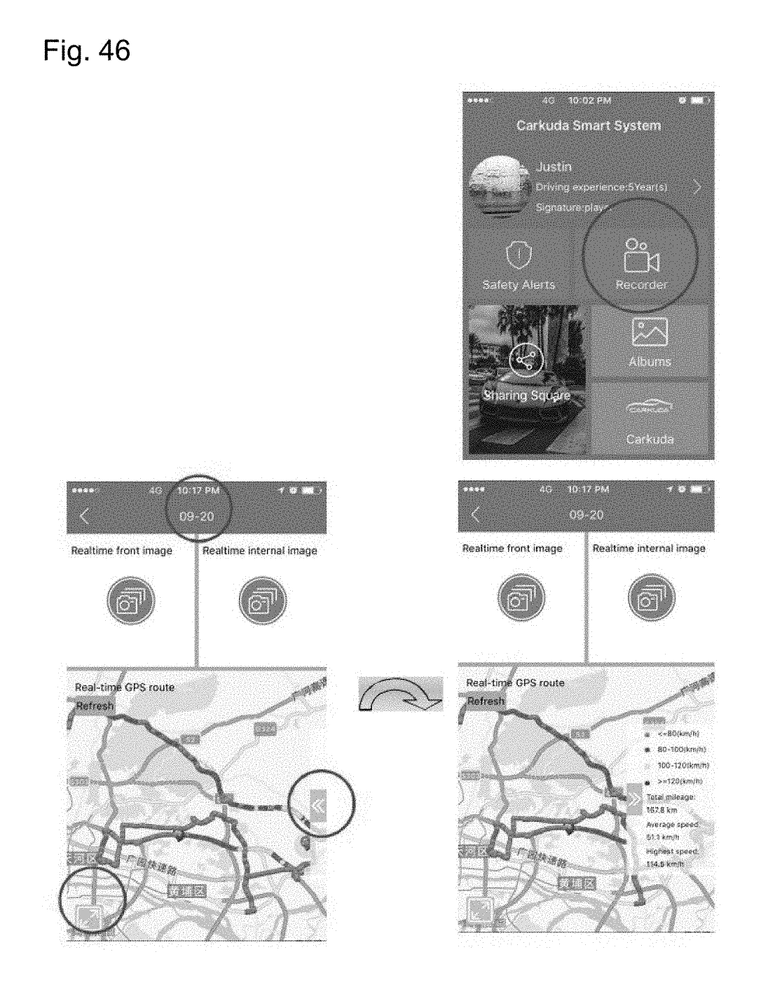

In FIG. 46, The second block is GPS tracker. Carkuda records all GPS locations and speeds. Distinguished by different colors, we are able to check where we drive over the speed limits. On the top of screen, we can change the date and see other historical data.

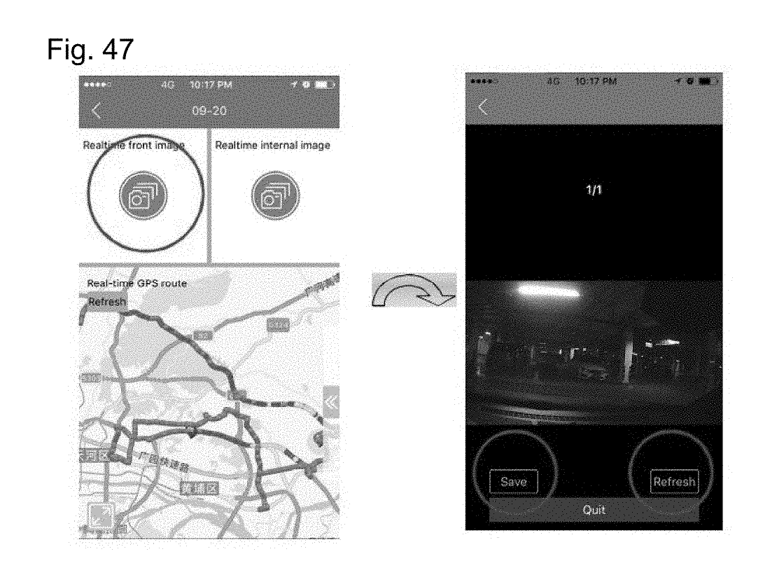

In FIG. 47, By click on the image button, and wait a little while, then we can see the DVR's live image feedback. On the other hand, Carkuda VTG500X supports single camera currently. [Realtime front image] will work only. Due to different network situation, users may experience different delay while waiting for image feedback. Users can save the image by clicking [Save] on left-bottom. Or press [Refresh] to request for new images.

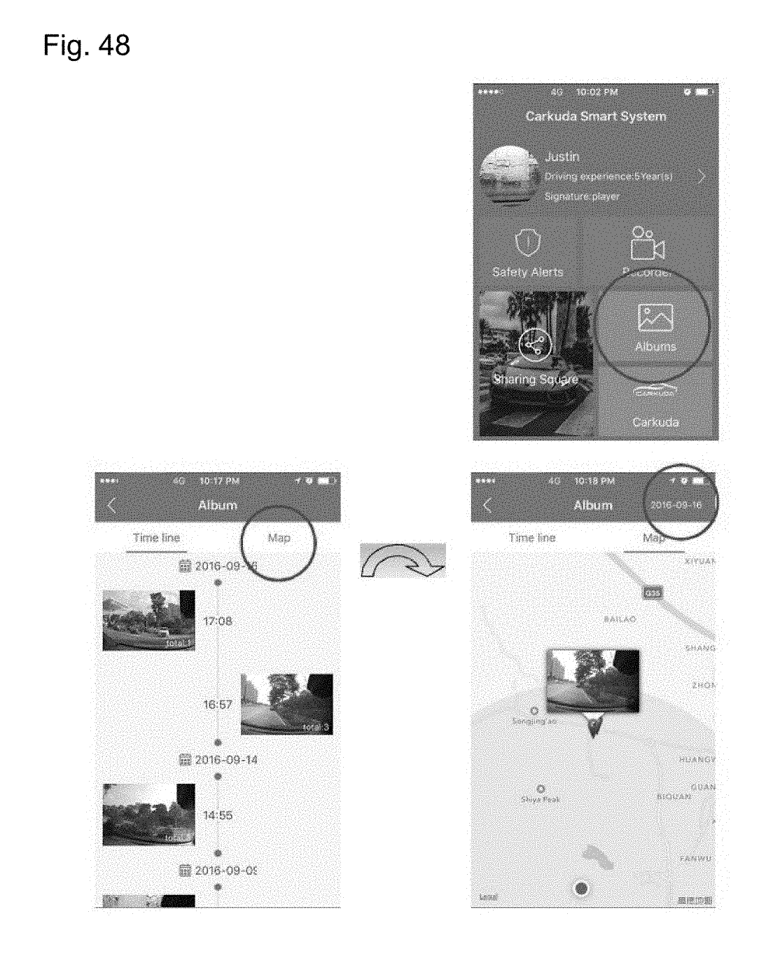

In FIG. 48, The third block is Photo album, the photos are all snapshots which is taken from the mirror. The photos are organized by time line and locations. By click on [Map] tab, user can switch to map view. By tap on right-top of screen, we can search for different date.

While the invention has been shown and described with reference to different embodiments thereof, it will be appreciated by those skilled in the art that variations in form, detail, compositions and operation may be made without departing from the spirit and scope of the invention as defined by the accompanying claims.

1. A rear view mirror system comprising:
one or more cameras configured for recording continuous video inside, outside, or around a vehicle, taking snapshots, and providing real time photo and video information to a plurality of remote monitoring devices on a user request;
a central control board that is equipped with an operating system and software packages for controlling operations of the one or more cameras;
a hidden screen display installed in a mirror of the vehicle and configured for providing operational information of the one or more cameras and the vehicle;
a touch pad connected electronically to the central control board for receiving user control actions; and
a wireless control button array configured for allowing a user to send action commands to mirror,
wherein at least one of the plurality of remote monitoring devices is configured for receiving and presenting the real time photo and video information from the one or more cameras and controlling the operations of the one or more cameras,
wherein the central control board is configured for controlling the hidden screen display and the touch pad.

2. The rear view mirror system of claim 1, wherein the one or more cameras comprises:
a front facing camera as a main camera;
a internal facing camera as backup camera;
a down-facing back camera for reverse parking video; and
a horizontally-facing back camera for rearview streaming.

3. The rear view mirror system of claim 1, wherein the hidden screen display is configured to be turned on and off by the user through the touch pad, the wireless control button array, or the central control board.

4. The rear view mirror system of claim 1, wherein at least one of the plurality of remote monitoring devices is linked with an Internet.

5. The rear view mirror system of claim 4, wherein the plurality of remote monitoring devices comprise a smartphone, a tablet computer, a notebook computer, a personal computer, and a server in the Internet.

6. The rear view mirror system of claim 5, wherein at least one of the plurality of remote monitoring devices comprises a plurality of remote control applications configured for:
receiving a real-time notification on engine start and engine stop, wherein the notification contains information of location of the vehicle, date, and time;
checking historical driving route records, wherein the historical driving route records contain locations and speeds of the vehicle and a total distance, an average speed, a maximum speed of the vehicle;
monitoring a vehicle real-time information, wherein the user requests and checks images or video streams from the front facing camera, the back facing camera, the internal facing cameras; and
reviewing historical photo records, which are exported, saved, and sorted by time and locations in the system.

7. The rear view mirror system of claim 6, further comprising a mirror software installed in the mirror, wherein the historical photos are captured by the cameras and saved in a mirror memory installed in the mirror, wherein the mirror software keeps checking availability of network connections and once a data network is connected, the mirror software uploads the captured historical photos to the server, and wherein the server sorts by time and locations, and organizes the records in a table storage, so that a user accesses the historical photos and records using at least one of the plurality of remote monitoring devices.

8. The rear view mirror system of claim 1, wherein an extended GPS antenna head is provided and connected to the mirror for stronger GPS signal receiving.

9. The rear view mirror system of claim 8, further comprising a back-end cloud database configured for storing data of the user, the vehicle, the one or more cameras, and GPS track.

10. The rear view mirror system of claim 1, further comprising a mirror software installed in the mirror and configured for allowing the user to:
review the historical video from the one or more cameras with functions including play, stop, delete of video files in the historical video;
input navigation destinations and select the navigation modes;
take instant real-time photos using the one or more cameras;
send a real-time SOS request by triggering SMS text messages and email messages in the plurality of monitoring devices; and
select, download, install, un-install new third party applications in the one or more monitoring devices.

11. The rear view mirror system of claim 4, wherein the mirror software further comprises an automotive software installed in the vehicle configured for operating the hidden screen display in the mirror without a user interaction in:
detecting the engine start/stop by sensors and start/stop DVR features automatically;
monitoring the G-sensor data, trigger snapshots if car is hit or stopped, causing G-sensor data sudden sharp change;
monitoring the vibrations during the vehicle's moving or parking and sending notification to remote monitoring applications;
monitoring and sensing temperature and humidity in the vehicle, so that once over limit threshold, the mirror software notifies remote monitoring applications;
keeping listening to a network connection for user's operation commands, and providing image or video feedback; and
setting up alarm after the engine is stopped, and bringing the mirror software offline/power off based on pre-set parameters.

12. The rear view mirror system of claim 1, further comprising a FM transmission component for redirecting audio information from the one or more cameras into an in-car radio system.

13. The rear view mirror system of claim 1, further comprising slots and connectors configured for installing SIM card, installing SD storage card, and connecting USB cables for debugging or data fetching.

14. The rear view mirror system of claim 1, further comprising a cable bundles configured for:
battery power;
ACC on/off detection power;
reverse parking detection;
temperature & humidity sensors;
vibration sensors; and
USB/video-in cables for the one or more cameras.

15. The rear view mirror system of claim 1, wherein the software packages comprise the mirror software installed in the mirror, a server software installed in the server for running the system, and a user software app installed in at least one of the plurality of remote monitoring devices.

16. The rear view mirror system of claim 1, wherein the hidden screen display is combined with the touch pad, so that the entire region of the hidden screen display works as the touch pad.
